(19) United States
(12) Patent Application Publication
(10) Pub. No.: US 2020/0085544 A1
(43) Pub. Date: Mar. 19, 2020

(54) DENTAL IMPLANT SYSTEM

(71) Applicant: Denta Vision GmbH, Berg (CH)

(72) Inventor: Alwin Schönenberger, Berg (CH)

(21) Appl. No.: 16/616,061

(22) PCT Filed: May 24, 2018
(86) PCT No.: PCT/EP2018/063718

§ 371 Date: Nov. 22, 2019

(30) Foreign Application Priority Data
May 26, 2017 (CH) 00687/17

(51) Int. Cl. A61C 8/00

(52) U.S. Cl. CPC A61C 8/0069; A61C 8/0059; A61C 8/0068

(57) ABSTRACT

A dental implant system including an implant, a prosthetics component, and a fastener. The implant and the prosthetics component are configured to assume a first taper connection and a second taper connection with one another. The implant has a male connection portion of the first taper connection. The prosthetics component is placed upon the implant and when the prosthetics component is not fastened to the implant by the fastener, a tolerance region is formed between the implant and the prosthetics component. The tolerance region is configured such that on fastening with the fastener, mating connection portions of the taper connections can be pushed further into one another.

### BACKGROUND OF THE INVENTION

### Field of the Invention

The invention relates to the field of dental medical technology, specifically to the field of dental implant systems.

### Description of Related Art

Known dental implant systems include an implant (also called “anchoring part”, or, if it is provided with an (outer) thread, a “screw”), which is anchored in the jawbone and can serve as artificial tooth roots. For this, the implant can include an (outer) thread on the outer surface of the enossal region, thus on the region that is envisaged to be sunk in the bone.

Dental implant systems can further include a construction part (also called “abutment”), which is provided for fastening on the implant. The superstructure (e.g., a crown, bridge or prosthesis) can be put onto the part of the implant or—if present—of the abutment (called “post” or “head” given the respective shape), which projects from the gums (gingiva). The implant, in particular an implant for connection to an abutment, can be designed such that it is incorporated roughly level with the bone surface (a so-called “bone-level” implant).

The implant can include a region that is configured to remain coronally of the bone surface. Such implants are so-called “tissue-level” implants and are configured to terminate roughly level with the soft tissue. Herein, the transmucosal region of the implant can be widened with respect to the enossal region (this shape is also called “tulip”). A further, special example of a “tissue-level” implant is a co-called monotype implant, which is configured to project beyond the mucosal region in the implanted state and to receive, e.g., a crown or an outer sleeve (e.g., for a bar restoration) in a direct manner, i.e., without the use of an abutment. In contrast to “bone-level” implants and classical “tissue-level” implants, monotype implants are 1-part implants, concerning which the implant and post or the implant and head are manufactured as one piece, i.e., the implant at the soft tissue boundary continues smoothly into the post or into the head.

Dental implants include counterparts that are placed onto the coronal end of the implant. A counterpart is hereinafter to be denoted as a “prosthetics component”. A prosthetics component can be designed as an abutment. A prosthetics component can be designed as a crown or as an outer sleeve (e.g., for a bar restoration).

The prosthetics component can be fastened in the implant by a positioning screw or an occlusal screw. The implant can include an opening on the coronally situated face side, the opening including an (inner) thread for receiving the screw. The prosthetics component can include structure features for receiving the screw, for example an opening.

A problem of conventional dental implant systems is the insufficient mechanical stability of the implants, in particular of those with a reduced diameter. Hairline cracks and fractures on the wall of the implant can therefore occur, such being able to arise under the influence of horizontal forces (thus, forces that act essentially perpendicularly to the implant axis) and of the torques that are produced by way of this. Micro-movements can lead to a loosening of the connection between the participating components and hence to damage, in particular to the implant in the course of the wearing time. Vertical forces, which can arise, for example, on fastening the prosthetics component or under functional loading on chewing, are also capable of compromising the mechanical stability of the implant. In particular, such problems in particular can be exacerbated if an extension of the prosthetics component that engages into the implant has the shape of a cone and can accordingly exert a wedging effect with a spreading action upon the implant wall.

A further problem of known dental implant systems is a possible loss of retention between the implant and the prosthetics component. Above all, this complication is extremely disadvantageous when the prosthetics component lies below a cemented restoration and access to the positioning screw is blocked due to this.

Another problem of known dental implant systems are gaps between the implant and prosthetics component. A reduction of such gaps is desirable from a biological as well as microbial point of view.

### SUMMARY OF THE INVENTION

It is an object of the invention to provide an improved dental implant system. In particular, the provided dental implant systems can be suitable for improving the state of the art with regard to one and/or more of the aforementioned problems.

In an embodiment, the dental implant system includes an implant and a prosthetics component that are designed to assume one, two or more taper connections with one another, thus clamping connections on clamping surfaces with steep inclinations. On account of the friction between the clamping surfaces, such taper connections permit a stable connection between the implant and the prosthetics component. A known example of a taper connection is a Morse taper connection. Due to the steepness of the clamping surfaces, a taper connection also stabilises with regard to movements in directions that are different to the connection direction, in particular with regard to directions that are orthogonal thereto.

The implant can be configured for anchoring in the bone tissue. In particular, the implant can be designed for being rotated into the bone tissue and include an (external) thread.

The prosthetics component can be configured to be put onto the implant. In particular, the prosthetics component can be configured to be inserted and/or to engage into the implant. The prosthetics component can be designed as an abutment, crown or outer sleeve.

The dental implant system can include a fastening means that is suitable for fastening the prosthetics component on the implant. The fastening means can be designed as a screw, for example as a positioning screw or as an occlusal screw. The implant and/or the prosthetics component can be configured for receiving the fastening means. In particular, the implant can include an inner thread for receiving a fastening means that is designed as a screw. The prosthetics component can includes recesses, in particular exactly fitting recesses, for receiving the screw body and/or the screw head.

The clamping surfaces of taper connections are designed essentially as lateral surfaces of general cones, thus of general cylinders which taper in one direction. A general cylinder can have any cross-sectional shape, thus be designed as a circular cylinder, an elliptical cylinder or a prism. In particular, a clamping surface can be designed as a lateral surface of a rotationally symmetrical truncated cone.

For a taper connection, the clamping surfaces are preferably very steep, in particular the clamping surfaces can have a tapering of less than 10°, in particular less than 8°, in particular less than 6°, in particular less than 4°, in particular less than 3°, in particular less than 2° or in particular less than 1°. The clamping surfaces can have a tapering of more than 0.1°, in particular of more than 0.5°, in particular of more than 1°, in particular of more than 2°, in particular of more than 3°, in particular of more than 4° or in particular of more than 5°. The clamping surfaces can include structure elements and on account of this can differ from the shape of a lateral surface of a general cone. Such structure elements can be designed as an orientation aid, positioning aid and/or a twist (rotation) protection.

An implant-side clamping surface can be designed as a steep bevelling on the coronal end of the implant, in particular on a coronal end-face of the implant.

A clamping surface can have a smooth surface.

A clamping surface can have a non-osseointegrative surface.

A taper connection includes a male connection portion and a female connection portion.

A male connection portion includes a connection portion that tapers in the connection direction and which includes an outer surface that is designed as a clamping surface.

A female connection portion includes a connection portion that widens in the connection direction and that includes an inner surface that is designed as a clamping surface.

The clamping surface of the male connection portion and the clamping surface of the female connection portion can be designed as a pair of clamping surfaces that are adapted to one another in an exactly matching manner.

The female connection portion can exert inwardly directed forces upon the male connection portion and therefore increase the mechanical stability of the male connection portion and/or parts that are adjacent thereto.

At a taper connection, the connection portion of the prosthetics component can be designed male and the connection portion of the implant designed female, and in this case one speaks of the connection portion of the implant receiving or clamping in the connection portion of the prosthetics component. Alternatively, the connection portion of the implant can be designed male and the connection portion of the prosthetics component designed female, and in this case one speaks of the connection portion of the prosthetics component receiving or clamping in the connection portion of the implant.

The implant can include an implant recess, which is arranged in the coronal face side of the implant. For this, the prosthetics component can be configured to engage into the implant recess on being placed onto the implant. The implant recess can be configured for receiving the fastening means. In particular, the implant recess can include an (internal) thread. The implant recess can be designed at least partly as a female connection portion of a taper connection.

The edges of a section of the implant, which are situated distally seen from the implant axis, along the implant axis, in particular along the coronal end of the implant can be designed as clamping surfaces of a male connection portion of a taper connection. The prosthetics component can clamp in the implant “from the outside” at these edges of a section of the implant along the implant axis which are situated distally seen from the implant axis. At such a connection, forces can act upon the implant from the outside to the inside and therefore increase the mechanical stability. For example, the edges of a section of the implant can be designed essentially as a lateral surface of a general cone, in particular of a rotationally symmetrically truncated cone, which tapers in the coronal direction.

Forces that act from the outside to the inside can be suitable so as to counteract forces that act from the inside to the outside, as can be caused for example by way of internal connections.

In an embodiment, the implant and the prosthetics component can be configured to assume two taper connections with one another.

It can be the case that a first taper connection blocks before a second taper connection on fastening and/or that a first taper connection is subjected to a different force than a second taper connection in a fastened state. By way of this, the force action upon individual parts of the dental implant system, in particular upon individual parts of the implant, can be controllable, by which means for example the mechanical stability of individual parts of the implant can be influenced in a targeted manner.

In an embodiment, the implant and the prosthetics component can be configured to assume two taper connections with one another,
wherein with regard to a first taper connection, the prosthetics component clamps the implant in, in particular from the outside, and
wherein with regard to the second taper connection, the prosthetics component clamps the implant in.

An example of such an embodiment is described in more detail hereinafter by way of FIG. 13.

The implant and the prosthetics component can be configured to assume two taper connections with one another,
wherein with regard to a first taper connection, the prosthetics component clamps the implant in,
wherein with regard to a second taper connection, the prosthetics component clamps the implant in,
wherein the second taper connection is arranged coronally of the first taper connection, and
wherein the (male) connection portion of the implant, which belongs to the second taper connection, in a direction orthogonal to the implant axis is narrower than the (male) connection portion of the implant, which belongs to the first taper connection.

The (male) connection portion of the implant, which belongs to the second taper connection, can be arranged at the coronal end of the implant. The (male) connection portion of the implant for the first and/or second taper connection can be designed as clamping surfaces on edges of the coronal end of the implant, which are situated distally seen from the implant axis. The prosthetics component can be configured to clamp the implant in from the outside at the first and/or second taper connection. The connection portion of the second taper connection can be designed as a coronal region of the implant and/or as a polygonal head (also called “external connection”) on the face side of the implant.

In an embodiment, the implant and the prosthetics component can be configured to assume two taper connections with one another,
wherein with regard to a first taper connection, the prosthetics component clamps the implant in, in particular from the outside, and
wherein with regard to a second taper connection, the implant clamps the prosthetics component in.

In particular, the implant-side clamping surface of the second taper connection can be arranged in an implant recess. Examples of such embodiments are hereinafter described in more detail, e.g., by way of FIGS. 3-13, 14 and 19.

The implant and the prosthetics component can be configured to assume two taper connections with one another,
wherein with regard to a first taper connection, the prosthetics component clamps the implant in,
wherein with regard to a second taper connection, the implant clamps the prosthetics component in,
wherein the (male) connection portion of the implant, which belongs to the first taper connection, is wider than the (male) connection portion of the prosthetics component, which belongs to the second taper connection.

The first and the second taper connection can be arranged essentially or at least partly at the same axial height of the implant. The first and the second taper connection can both be arranged at the coronal end of the implant. The prosthetics component can be configured to clamp the implant in from the outside at the first taper connection. The (male) connection portion of the implant for the first taper connection can be designed as clamping surfaces on edges of the coronal end of the implant that are situated distally seen from the implant axis. The (female) connection portion of the implant for the second taper connection can be designed as clamping surfaces on edges of the coronal end of the implant that are situated proximally seen from the implant axis. The (female) connection portion of the implant for the second taper connection can be arranged on and/or in the implant recess. The first and the second taper connection can clamp in opposite directions, thus be configured such that the force actions of the first and of the second taper connection, which are projected onto a plane that is perpendicular to the implant axis, are essentially counter to one another; and the mechanical stability of regions of the implant that are clamped counter to one another can be increased by way of this.

The clamping surface of a connection portion of the prosthetics component can be essentially equally long in the connection direction as the clamping surface of a corresponding connection portion of the implant.

The clamping surface of a connection portion of the prosthetics component can be designed essentially shorter in the connection direction than the clamping surface of a corresponding connection portion of the implant.

The clamping surface of a connection portion of the prosthetics component can be designed essentially longer in the connection direction than the clamping surface of a corresponding connection portion of the implant.

The female connection portion of a taper connection, between the implant and the prosthetics component can be designed to essentially completely receive the corresponding male connection portion.

The female connection portion of a taper connection, between the implant and the prosthetics component can be designed to only partly receive the corresponding male connection portion.

A prosthetics component, which is designed as an abutment, can include a jacket, thus a region which can be put over the coronal implant region in the manner of a cap. The jacket can be designed for assisting in the veneering material. The prosthetics component, which is designed as an abutment, can be designed for receiving bonded or cemented crowns.

In an embodiment, the prosthetics component can be configured to clamp the implant in from the outside at its coronal end at a taper connection. Herein, the (female) connection portion of the prosthetics component can be configured to essentially completely receive the (male) connection portion of the implant. In particular, the clamping surface of the (female) connection portion of the prosthetics component can be designed essentially equally long in the connection direction as the clamping surface of the (male) connection portion of the implant. In this case, a prosthetics component, which is designed as an abutment, can extend further laterally subsequent to the clamping surfaces, in order to form a jacket, which in the manner of a cap, can be pushed over the implant region, which is apically subsequent to the taper connection.

A female connection portion and a male connection portion of a taper connection can be configured such that the female connection portion does not completely receive a corresponding male connection portion. In particular, the clamping surface of the female connection portion can be shorter in the connection direction than the clamping surface of the male connection portion. For example, the length of the clamping surface of the female connection portion in the connection direction can be at the most 75%, in particular at the most 50%, of the length of the clamping surface of the male connection portion in the connection direction.

In an embodiment, the implant can include two taper connection portions,
wherein the two connection portions of the implant are formed on the coronal end of the implant, and
wherein the first connection portion of the implant is designed as an outer-lying, male connection portion, and
wherein the second connection portion of the implant is designed as an inner-lying, female connection portion, in particular as part of an implant recess.

In this context, the term “outer” is to denote the edges of the coronal end of the implant that are situated distally seen from the implant axis; the term “inner” in this context is to denote the edges of the coronal end of the implant that are situated proximally seen from the implant axis.

A cross section of the implant, in particular a cross section through a plane that includes the implant axis can encompass the implant axis, the direction of the fastening force and/or the direction of a taper connection.

A cross section of the implant, in particular a cross section through a plane that includes the implant axis can include two elevations, wherein the side of the elevations which is situated distally of the implant axis is realised by the outer, male connection portion of the implant, and the side of the elevation that is situated proximally of the implant axis is realised by the inner, female connection portion of the implant.

In a cross section of the implant, in particular a cross section through a plane which includes the implant axis, an edge of the outer-lying male connection portion can be longer, shorter and/or essentially equally long as an edge of the inner-lying female connection portion of the implant.

In a cross section of the implant, in particular a cross section through a plane that includes the implant axis, an edge of the outer-lying male connection portion of the implant can be at least 0.5 mm long.

In a cross section of the implant, in particular a cross section through a plane that includes the implant axis, an edge of the outer-lying male connection portion of the implant can be 3 mm long at the most.

In a cross section of the implant, in particular a cross section through a plane that includes the implant axis, an edge of the inner-lying female connection portion of the implant can be at least 0.5 mm long.

In a cross section of the implant, in particular a cross section through a plane that includes the implant axis, an edge of the inner-lying female connection portion of the implant can be 3 mm long at the most.

In a cross section of the implant, in particular a cross section through a plane that includes the implant axis, the edge of the outer-lying male connection portion of the implant can be designed so as to lie at least partly within the bone, thus apically of the bone boundary, in the implanted state. In particular, the implant can be designed as a “bone-level” implant.

An outer-lying male connection portion of the implant and/or an inner-lying female connection portion of the implant can be designed as a steep bevelling on a face side of the implant.

The counterpart of a connection portion of the implant which is designed as an outer bevelling on the coronal end-face of the implant can be designed as a barrel-ring-shaped connection portion of the prosthetics component. Such a barrel-ring-like connection portion of the prosthetics component is hereinafter also to be called a stabilisation ring. In particular, a stabilisation ring can only have a narrow ring surface. For example, a stabilisation ring can be less than 1.5 mm, in particular less than 1 mm, in particular less than 0.5 mm wide. A stabilisation ring can be configured to counteract forces, which are exerted by an inner-lying male connection portion of the prosthetics component onto portions of the implant.

The transmucosal region of a “tissue-level” implant can be widened compared to the enossal region and form a so-called “tulip”. An outer-lying male connection portion of the implant and/or an inner-lying female connection portion of the implant can be designed as a steep bevelling on a coronal face side of the tulip.

A “tissue-level” implant, thus an implant that includes a region which is configured to remain coronally of the bone surface can include a male connection portion which is situated distally of the implant axis and is arranged at the coronal end. A connection portion of the implant can be spaced from the enossal part. The distance between the connection portion of the implant and the enossal part can be more than 1 mm, in particular more than 2 mm, in particular more than 3 mm. A connection portion can be spaced from the enossal part for example by a flat support shoulder. The flat support shoulder can be designed essentially as a circular cylinder.

In an embodiment, an outer-lying connection portion of the implant, which is designed male, can be arranged on a coronal face side of the implant. This connection portion can be designed as a bevelling on the face side. For example, the bevelling at the most can be 1 mm long, in particular 0.5 mm long. With regard to a “tissue-level” implant, this bevelling can be spaced from the enossal part. The distance to the enossal part of the implant can be more than 1 mm, in particular more than 2 mm, in particular more than 3 mm.

With regard to a “monotype” implant, the clamping surface of an outer connection portion, which is designed male, can be configured to run partly coronally and partly apically of the soft tissue boundary.

The implant and the prosthetics component can be designed such that a tolerance region is formed between the implant and the prosthetics component in the inserted but not fastened state. In particular, the implant and the prosthetics component can be configured such that two, in particular three, in particular four, in particular more than four tolerance regions are formed between the implant and the prosthetics component in the inserted, but non-fastened state.

Tolerance regions can be designed such that mating connection portions of a taper connection can be inserted further into one another on fastening. By way of this, the male connection portion can sink into the female connection portion on fastening. For example, the tolerance regions can be designed to permit a slight play in the direction of the respective associated connection, by which means a mechanical insertion of the corresponding connection portions further into one another under the influence of the fastening force is rendered possible. On account of the arising barrel-ring effect, the connection between the implant and the prosthetics component can be strengthened and/or the mechanical stability of the implant increased.

Gaps between the implant and the prosthetics component, in particular gaps between the clamping surfaces of a taper connection can be reduced in size, in particular minimised, by way of the combination of taper connections and tolerance regions. By way of this, a precise marginal seal, a precise fit between the implant and the prosthetics component can be achieved, which entails advantages from a mechanical, biological and/or microbial point of view.

The participating portions can sink further into one another on fastening and an additional friction fit between the clamping surfaces of the respective portions can arise due to the combination of taper connections and tolerance regions. By way of this, one succeeds in the force that is necessary for detachment being able to be greater than the force which is required or mustered for the fastening.

A tolerance region can be designed as a distance in the direction of the fastening force.

A tolerance region can be designed as a distance in the direction of the taper connections, thus essentially in the direction of the steep inclinations.

A tolerance region can be designed as a distance in the apical-coronal direction.

A tolerance region can be arranged, for example, at a coronal or apical end of a taper connection.

A tolerance region can be arranged between a plane surface of the implant and a plane surface of the prosthetics component.

A tolerance region in a cross section, in particular in a cross section through a plane that includes the implant axis can essentially be designed as a trapezium. In particular, it can be the case,
that a first of the parallel sides of the trapezium is realised by a plane surface of the implant; and/or
that a second of the parallel sides is realised by a plane surface of the prosthetics component.

In a cross section, it can be that one or both non-parallel sides of the trapezium can be designed as a continuation of an oblique side, which in the cross section represents a clamping surface.

A distance between the implant and the prosthetics component can be formed, for example, in the direction of the fastening force and/or in the direction of the taper connections and/or in the apical-coronal direction.

In an inserted state, a distance between the implant and the prosthetics component in a tolerance region can be at least 50 μm. In particular, in an inserted state, a distance in a tolerance region can be at least 100 μm, in particular at least 150 μm, in particular at least 200 μm.

The implant and the prosthetics component can be configured, in a tolerance region, to have a distance that, in the fastened state, is reduced by at least 25% compared to a non-fastened state. In particular, a tolerance region in a fastened state can have a distance that is reduced by at least 50%, in particular by at least 75%.

The implant and the prosthetics component can be configured such that in a tolerance region, they have a distance of at the most 50 μm in a fastened state. In particular, a distance in a tolerance region can be at the most 100 μm in a fastened state.

The implant and the prosthetics component can be configured such that in a fastened state, in a tolerance region they have a distance of at least 20 μm. In particular, a distance in a tolerance region can be at least 30 μm in a fastened state.

Each taper connection can include at least one associated tolerance region. A taper connection can include at least two associated tolerance regions. Each taper connection can include at least two associated tolerance regions.

A tolerance region can include at least two associated taper connections. Each tolerance region can include at least two corresponding taper connections.

A tolerance region can be directly or indirectly adjacent to an associated taper connection. A tolerance region can be arranged coronally of an associated taper connection. A tolerance region can be arranged apically of an associated taper connection. A tolerance region can be arranged laterally of an associated taper connection.

An extension portion can be subsequent to a connection portion of a taper connection in the connection direction or a direction that is opposite to this. An extension portion can be designed, for example, as a non-tapering general cylinder. A tolerance region that belongs to the connection can be arranged at an end of an extension portion. In such a case, the tolerance region permits the remotely lying taper connection portions to be pushed further into one another, wherein the extension portion is co-pushed. An extension portion can be arranged coronally and/or apically of a connection portion of an implant or of a prosthetics component.

In an embodiment, the dental system can be configured such that small lateral gaps are formed between the implant and the prosthetics component in the inserted state. These lateral gaps can be configured such that the prosthetics component can be pushed into the implant without a large friction resistance. The lateral gaps can have a width, e.g., of 50 μm at the most. In particular, the lateral gaps can have a width of 40 μm at the most, in particular 30 μm at the most. The lateral gaps can be dimensioned such that the user does not have the feeling that the prosthetics component wobbles in the implant in the inserted state. In particular, the lateral gaps can be dimensioned such that a fastening means can be inserted without changing the position of the prosthetics component in the implant.

In an embodiment, the fastening means can be designed as a screw. In this case, the implant and/or the prosthetics component can include a screw thread for receiving the screw. Furthermore, the prosthetics component can include a slide hole for introducing the screw.

In an embodiment, a fastening means, which is designed as a screw, and the prosthetics component can be designed to assume a taper connection with one another. For example, the screw can include the male connection portion and the prosthetics component the female connection portion of such a connection. In particular, the apical end of the head of the screw can be designed as a connection portion with a clamping surface; for example, the apical end of the head of the screw can be designed as a truncated cone, in particular as a truncated cone that tapers in the apical direction.

The dental implant system can include an orientation aid, a positioning aid and/or a twist (rotation) protection. An orientation aid, a positioning aid and/or a twist (rotation) protection can be designed as structure elements in the implant and/or in the prosthetics component. Such structure elements can also be used for a dental implant system without a taper connection.

Structure elements of the implant and of the prosthetics component can be matched to one another for example in pairs, so that mating structure elements engage in one another when the prosthetics component is placed onto the implant and/or fastened. Structure elements of the implant and of the prosthetics component can be designed matching one another in a precise manner, in particular with a positive fit.

Structure elements can be designed to simplify the orientation of the prosthetics component on insertion into the implant.

Structure elements can be designed to permit the insertion of the prosthetics component into the implant in only one position, or only in a small number of positions, for example two, three, four or six positions.

Structure elements can be designed to hinder, in particular to prevent, a rotation, in particular a rotation that is transmitted on fastening, of the prosthetics component with respect to the implant.

Structure elements can be designed as grooves and/or notches, in particular as grooves and/or notches that run axially from the implant axis. For example, the implant can include grooves and the prosthetics component can include notches that are matched thereto. For example, the implant can include notches and the prosthetic component grooves that are matched thereto. For example, the implant as well as the prosthetics component can include notches and projections that are matched thereto. The dental implant system can include, e.g., precisely or at least one, two, four, six or eight notches and/or projections.

Structure elements of the implant can be arranged in an implant recess. Structure elements of the implant can be arranged symmetrically, in particular rotationally-symmetrically to the implant axis.

Structure elements can be arranged on and/or in clamping surfaces of a taper connection. Structure elements can be arranged in the clamping surfaces and, in particular, can be designed such that the respective clamping surface differs from the shape of a lateral surface of a general cone, but despite this is suitable as a connection portion for a taper connection. The arrangement of structure elements in a clamping surface can assist in the design of shorter implants.

Structure elements can be arranged apically and/or coronally of a clamping surface. For example, structure elements can be arranged in an extension portion that is apically or coronally subsequent to a clamping surface. If the implant includes structure elements that are arranged apically (or coronally) of the clamping surfaces, then the prosthetics component can include corresponding structure elements that are arranged apically (or coronally) of the clamping surfaces.

Structure elements can be configured not to inhibit the insertion into one another, in particular a further insertion into one another, of connection portions of a taper connection.

Structure elements can be formed in the connection direction and in particular extend in the connection direction. In particular, a structure element in a cross section through a plane, in particular through a plane that encompasses the implant axis can include edges in the direction of the implant axis, in the direction of the fastening force and/or in the direction of a taper connection.

A structure element can have an essentially box-shaped geometry. A structure element in a clamping surface of a taper connection can be designed locally, e.g., as a section of a cuboid with a general cone. In particular, a side of the cuboid can be orientated in the direction of the implant axis, in the direction of the fastening force and/or in the direction of a taper connection.

An essentially box-shaped structure element can taper in one, two or more directions, in particular in the apical or coronal direction, in the connection direction or in a direction that is opposite thereto. Such a tapering of a structure element can be configured as a connection portion of a taper connection of the dental implant system.

A structure element can include an essentially box-shaped portion. A structure element can include a tapering, essentially box-shaped portion.

In an embodiment, a dental implant system can include:
an implant for anchoring in the bone tissue,
a prosthetics component, which is configured to be placed onto the implant, and
a fastening means, which is suitable for fastening the prosthetics component to the implant.

The implant and the prosthetics component can be configured to assume a first taper connection and a second taper connection with one another, wherein the implant includes the male connection portion of the first taper connection. The dental implant system can be configured such that:
when the prosthetics component is placed upon the implant and
when the prosthetics component is not fastened to the implant by the fastening element, a tolerance region is formed between the implant and the prosthetics component, the tolerance region being configured such that on fastening with the fastening means, mating connection portions of the taper connections can be pushed further into one another.

In an embodiment:
the implant-side connection portion of the first taper connection and/or
the implant-side connection portion of the second taper connection can be arranged at the coronal end of the implant.

In an embodiment, the implant-side connection portion of the second taper connection can be designed as a female connection portion. In particular, the implant-side connection portion of the second taper connection can be designed as part of an implant recess.

In an embodiment, the implant-side connection portion of the second taper connection can be designed as a male connection portion. In particular, the implant-side connection portion of the first taper connection can be arranged at the coronal end of the implant, and the implant-side connection portion of the second taper connection can be arranged on a surface of the implant, which is distal to the implant axis. In particular, the implant-side connection portion of the second taper connection can be arranged apically of the implant-side connection portion of the first taper connection.

In an embodiment, the angle of the clamping surfaces of the first taper connection and/or of the second taper connection to the implant axis can be 8° or less than 8°.

In an embodiment, the length of the projection of a clamping surface of the implant onto the implant axis is 1 mm at the most.

In an embodiment, a tolerance region in the non-fastened state can be designed as a distance between the implant and the prosthetics component in the coronal-apical direction. In particular, the distance between the implant and the prosthetics component in the coronal apical direction in the non-fastened state can be at least 100 μm.

In an embodiment, the fastening means can include a thread. In particular, the fastening means can be designed as a screw.

In an embodiment, the implant and/or the prosthetics component can include structure elements that are designed as an orientation aid, a positioning aid and/or a twist (rotation) protection.

In an embodiment, the structure elements can be designed as projections and corresponding notches. In particular, the projections and notches can be designed at least essentially box-shaped. The grooves and notches can taper in the coronal and/or apical direction.

In an embodiment, one or more structure elements can be arranged in the connection portions.

In an embodiment, one or more structure elements can be arranged apically of the connection portions.

In an embodiment, the prosthetics component can be designed as an abutment, crown or outer sleeve.

A method for fastening a dental implant system of a previously described dental implant system can include the following method steps:
a) the prosthetics component is placed onto the implant; and
b) the prosthetics component is subsequently fastened to the implant by the fastening means, wherein mating connection portions of the taper connections are pushed further into one another on fastening.

### BRIEF DESCRIPTION OF THE DRAWINGS

The subject-matter of the invention is explained hereinafter in more detail by way of preferred embodiment examples which are represented in the accompanying drawings. There are shown schematically in (and not necessarily true to scale):

FIG. 1 a detail of a cross section of an implant with two taper connection portions;

FIG. 2 a detail of a cross section of an implant with a long, inner taper connection portion;

FIG. 3 a detail of a cross section of an implant and of a prosthetics component, which is placed thereon, with two taper connections and tolerance regions;

FIG. 4 a detail as in FIG. 3, wherein the prosthetics component is fastened on the implant by way of a fastening means and the tolerance regions are reduced in size;

FIG. 5 an enlarged detail of a cross section of an implant and of a prosthetics component, with a tolerance region situated therebetween,

FIG. 6 an enlarged detail of a cross section of an implant and a prosthetics component, with a tolerance region located therebetween, wherein the prosthetics component at the outside includes a long connection portion;

FIG. 7 a detail of a cross section of a dental implant system with a cemented crown;

FIG. 8 a detail of a cross section of a dental implant system with a veneered prosthetics component which is designed as an abutment, wherein the abutment includes a jacket;

FIG. 9 a cross section of an implanted dental implant system with a “bone-level” implant,

FIG. 10 a cross section of an implanted dental implant system with a “monotype” configuration;

FIG. 11 a cross section of an implanted dental implant system with a “tissue-level” implant with a cylindrical neck;

FIG. 12 a cross section of a further implanted dental implant system with a “tissue-level” implant with a tulip-shaped neck;

FIG. 13 a cross section of an implanted dental implant system with an external connection;

FIG. 14 a cross section of a further implanted dental implant system with a “bone-level” implant;

FIG. 15 a plan view onto an implant with structure elements, from the coronal direction;

FIG. 16 a plan view onto an implant with tapering structure elements, from the coronal direction;

FIG. 17 various box-shaped structure elements;

FIG. 18 a detail of a perspective view onto an implant recess with structure elements in a clamping surface;

FIG. 19 a detail of a cross section of an implant with a notch and a prosthetics component with a groove.

### DETAILED DESCRIPTION OF THE INVENTION

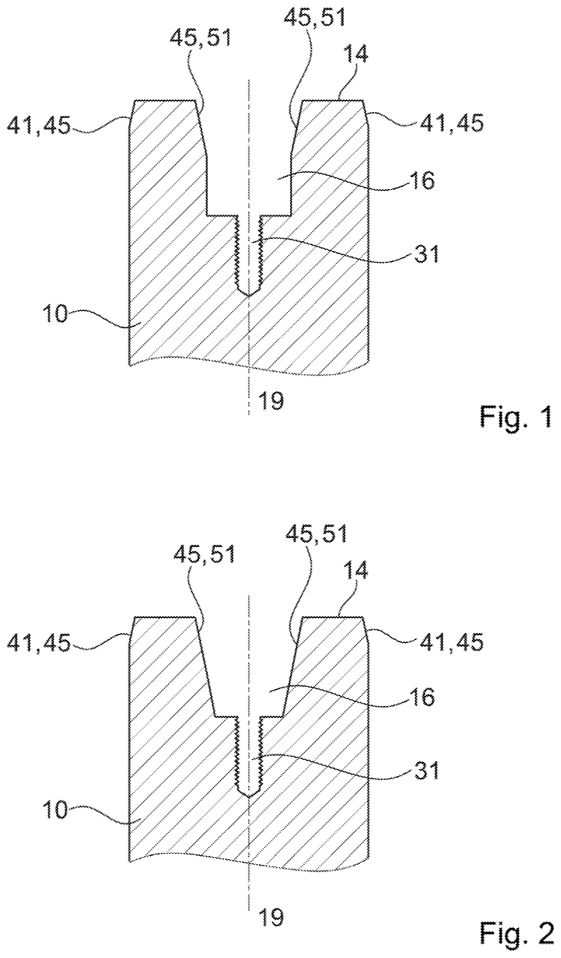

FIG. 1 shows a cross section through an oral implant 10 of a dental implant system 1. The implant 10 is configured such that a prosthetics component (not shown) can be placed onto the implant 10 and be fastened to the implant 10 by a fastening means (not shown).

The implant 10, which is represented in FIG. 1, includes an implant recess 16 at a coronal end 14. The implant recess 16 includes a fastening means recess 31 for receiving a fastening means 30. The fastening means recess 31 can be designed, for example, as a thread, in order to receive a fastening means 30, which is designed as a screw.

The shown implant 10 is configured to assume a first taper connection and a second taper connection, with a prosthetics component 20. A taper connection is a clamping connection on clamping surfaces 45 with steep tapers. A known example of a taper connection is the so-called Morse taper connection. The clamping surfaces 45 can be designed, for example, essentially as lateral surfaces of general cones, thus, for example, general cylinders that taper in one direction. For example, the clamping surfaces 45 can be designed essentially as rotationally symmetrical truncated cones. A symmetrical shape of a clamping surface 45 can be interrupted for example by way of structure elements (not shown) such as notches (not shown) and projections (not shown), the elements being able to function as an orientation aid, positioning aid and/or twist (rotation) protection and are described in more detail hereinafter.

In the represented example, the implant 10 includes a connection portion 41 for a first taper connection and a connection portion 51 for a second taper connection, thus in total two steep clamping surfaces 45. In the shown example, the two clamping surfaces 45 are arranged at the coronal end 14 of the implant 10. The angle of a clamping surface 45 to the implant axis 19 can be for example 8° or less.

In the shown example, the clamping surface 45 of the implant-side connection portion 41 of the first taper connection is arranged on the implant 10 at the outside, thus on an edge of the implant 10, which is situated distally seen from the implant axis 19. In the shown cross section, this clamping surface 45 is represented as a bevelling of the coronal end 14 of the implant 10 at the upper left as well as upper right edge of FIG. 1. The clamping surface 45 can be designed, for example, as a surface of a truncated cone about the implant axis 19, the clamping surface moreover being able to include structure elements (not recognisable in the shown cross section).

In the shown example, the clamping surface 45 of the implant-side (belonging to the implant) connection portion 41 of the first taper connection is designed as a male connection portion. A male connection portion is configured to be received by a female connection portion. A male connection portion tapers in the connection direction; whereas a female connection portion widens in the connection direction. The female connection portion can exert inwardly directed forces onto the male connection portion, and therefore increase the mechanical stability of the male connection portion and/or of the parts which are adjacent thereto.

In the shown example, the clamping surface 45 of the implant-side connection portion 51 of the second taper connection is arranged on the implant 10 at the inside. Expressed more precisely, this clamping surface 45 is arranged in the implant recess 16 and forms its coronal end. In the shown cross section, this clamping surface 45 is represented as bevellings at the coronal end of the implant recess 16. This clamping surface 45 can also be designed, for example, as a surface of a truncated cone, out of which optionally notches (not recognisable in the shown cross section) can be recessed and/or onto which the projections (not recognisable in the shown cross section) can be placed.

In the shown example, the clamping surface 45 of the implant-side connection portions 51 of the second taper connection 50 are designed as a female connection portion, thus widens in the connection direction.

FIG. 2 shows a cross section similar to that of FIG. 1. In this example, the clamping surface 45 of the implant-side connection portion 51 of the second taper connection 50 is, however, lengthened on comparison to FIG. 1. In particular, the projection of the cross section of the clamping surface 45 onto the implant axis 19 is lengthened. By way of this, the surface of the clamping surfaces can be enlarged and the taper connection therefore strengthened, by which means a surface of the clamping surfaces, which is reduced by structure elements (not shown) of an orientation aid, of a positioning aid and/or of a twist (rotation) protection can be compensated.

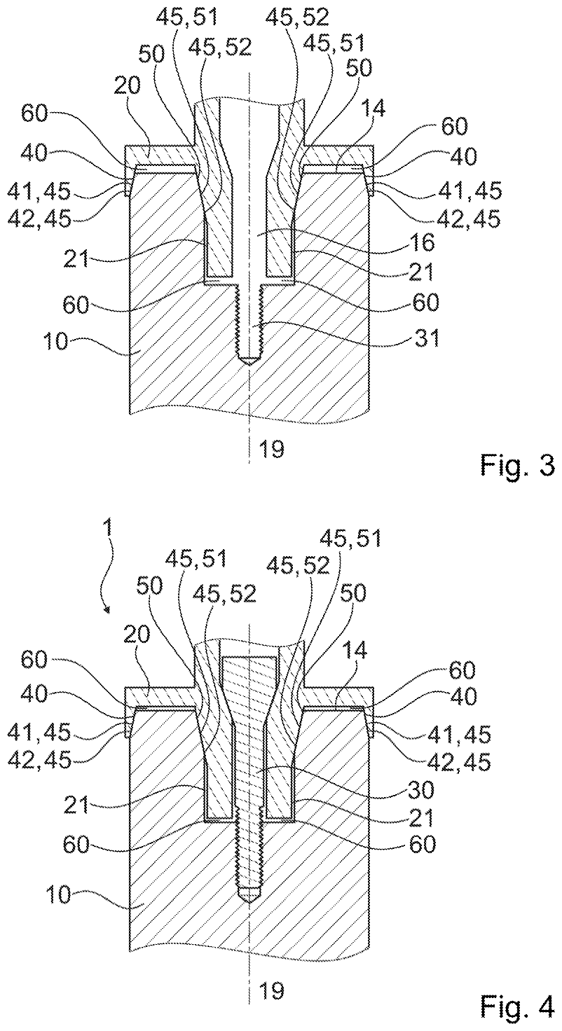

FIG. 3 shows the cross section of the implant 10 similarly to that of FIG. 1 or FIG. 2 as well as of a prosthetics component 20, which is placed upon this. In the shown example, the prosthetics component 20 is designed as an abutment. Alternatively, the prosthetics component can be designed, for example, as a crown or outer sleeve (e.g., for a bar restoration) as can be the case, for example, with monotype implants, as is shown, for example, in FIG. 10. Very small lateral gaps 21, which are designed as vertical slots, are arranged in the implant recess 16 between the implant 10 and the abutment 20. These can be dimensioned such that the abutment 20 can be pushed into the implant 10 without a large friction resistance and the abutment 20 despite this is stable and can be inserted in the implant 10 essentially without play.

The abutment 20 includes a connection portion 42 for the first taper connection as well as a connection portion 52 for the second taper connection. A connection portion 42, 52 of the abutment can be designed in a manner corresponding to a corresponding connection portion 41, 51 of the implant 10, for example shaped at least partly as its negative.

In the shown example, the abutment-side (belonging to the abutment) connection portion 42 of the first taper connection 40, which is situated at the outside, is designed as a female connection portion and is configured to receive the implant-side connection portion 41, which is designed male. In contrast to this, the abutment-side connection portion 52 of the inner-lying second taper connection 50 is designed as a male connection portion and is received by the implant-side connection portion 51 which is designed female.

In the shown placed-on state, two tolerance distances 60 are formed between the implant 10 and the abutment 20.

One of the shown tolerance distances 60 is arranged at the coronal end 14 of the implant 10. In the cross section of FIG. 3, this tolerance distance 60 is represented as two-dimensional gaps between the lateral portions of the abutment 20 and the coronal end 14 of the implant 10, but consists of a single three-dimensional gap between the abutment 20 and the implant 10.

A further represented tolerance distance 60 is arranged at the apical end of the abutment 20.

FIG. 4 shows a dental implant system 1, including an implant 10 and a prosthetics component 20 that is designed as an abutment, similarly to those of FIG. 3, as well as fastening means 30, by way of which the abutment 20 is fastened to the implant 10. In the shown example, the fastening means 30 is designed as a screw, which engages into a fastening means recess 31 of the implant 10, which is designed as a screw thread.

The tolerance regions 60 which, similarly to the example of FIG. 3, were arranged at the coronal end of the first and second taper connection 40, 50 as well as at the apical end of the second taper connection 50 between the implant 10 and the abutment 20 have made it possible for the mating connection portions of the taper connections 40, 50 to be inserted further into one another on fastening with the fastening means 30, by which means the tolerance regions 60 have been reduced—as is represented in FIG. 4. The connection between the implant 10 and the abutment 20 can be strengthened and/or the mechanical stability of the implant increased due to the arising barrel-ring effect.

By way of the combination of taper connections 40, 50 and tolerance regions 60, gaps between the implant 10 and the prosthetics component 20, in particular gaps between the clamping surfaces 45 of a taper connection 40, 50 can be reduced in size, in particular minimised. By way of this, a precise marginal seal between the implant 10 and the prosthetics component 20 and/or or a precise fit between the implant 10 and the prosthetics component 20 can be achieved.

The fastening means 30, which are designed as a screw in this example, and the prosthetics component 20—as is shown in this example—can be configured to assume a taper connection with one another. In the shown example, the prosthetics component 20 includes the female connection portion and the screw 30 the male connection portion of this connection. As is shown in this example, the apical end of the head of the screw can be designed as the male connection portion of the connection, which can be designed for example as a truncated cone which tapers in the apical direction.

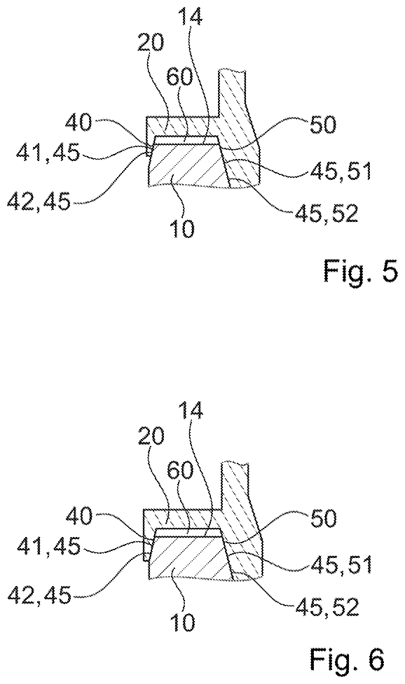

FIG. 5 shows a detail of a cross section of an implant 10 and of a prosthetics component 20, which is put onto this and which is designed as an abutment, in the placed-on but non-fastened state. A tolerance distance 60 is arranged between the abutment 20 and the implant. A first taper connection 40 is arranged at the outer edge of the coronal end 14 of the implant 10. The abutment-side connection portion 42 of this first taper connection is designed in a relatively short manner: the clamping surface 45 of the abutment 20 is shorter in the connection direction than the clamping surface 45 of the implant 10. In the shown example, the connection portion 42 of the abutment 20 can be designed as a thin stabilisation ring that, for example, can be less than 1 mm wide. A shortened form of the abutment-side connection portion 42 can be used, for example, for “bone-level” implants. By way of this, an interference, for example between the abutment 20 and the bone (not shown), can be prevented.

FIG. 6 similarly to FIG. 5 shows a detail of a cross section of an implant 10 and of a prosthetics component 20, which is placed onto this and is designed as an abutment, in the placed-on, but non-fastened state. A tolerance distance 60 is arranged between the abutment 20 and the implant. In comparison to FIG. 5, the abutment-side connection portion 42 of this first taper connection 40 is designed in a relatively long manner: the clamping surface 45 of the abutment 20 is longer in the connection direction than the clamping surface 45 of the implant 10. The two clamping surfaces 45 can also be designed equally long. The abutment-side clamping surface 45, which is lengthened in comparison to FIG. 5, leads to an enlarged contact surface of the connection 40 and therefore improves the connection between the implant 10 and the prosthetics component 20.

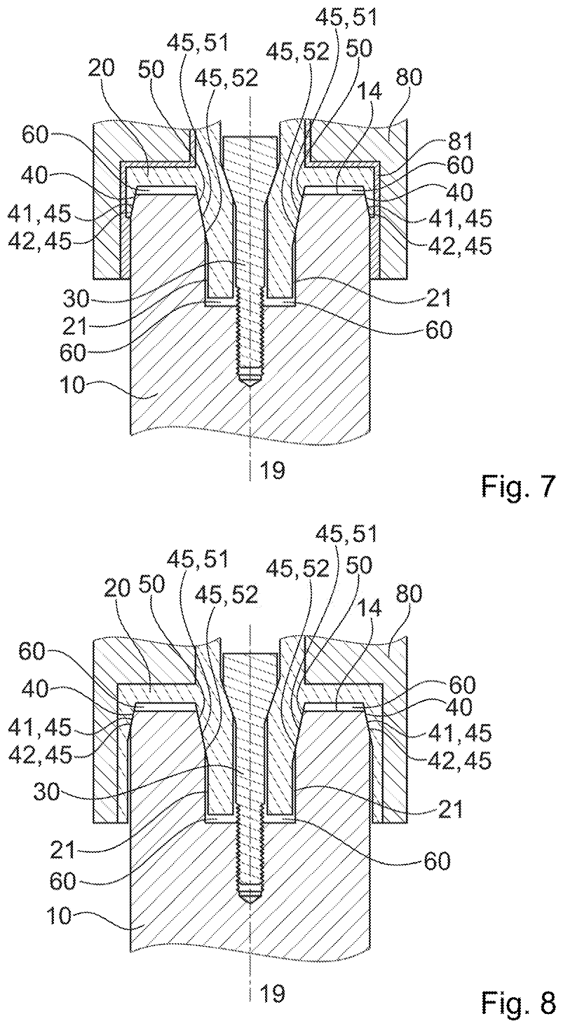

FIG. 7 shows a dental implant system with an implant 10 and with a prosthetics component 20, which is placed upon this and which is designed as an abutment, in a fastened state, which has been realised by a fastening means 30. In the shown fastened state of this example, tolerance distances 60 are reduced compared to a placed-on, but non-fastened state (not shown), and by way of this the implant 10 and the abutment 20 are pushed further into one another on the two taper connections 40, 50.

Furthermore, a crown 80, which can be placed over the abutment and which serves as a denture, is shown in FIG. 7. The dental implant system can be configured for the crown 80 to be bonded or—as shown in FIG. 7—cemented with cement 81.

FIG. 8 shows a further example of a dental implant system in the fastened state with a crown 80. In this example too, the tolerance distances 60 are reduced compared to a placed-on, but non-fastened state (not shown). The prosthetics component 20, which is designed as an abutment in this example, includes a so-called jacket, thus an apically extending region that encompasses the implant 10 from the outside. In the shown example, the jacket extends over the implant in the apical direction from the abutment-side clamping surface 45 of the first taper connection 40. Such a jacket can be used in order to precisely define the gap between the implant 10 and the abutment 20 and to define the extent of the capping.

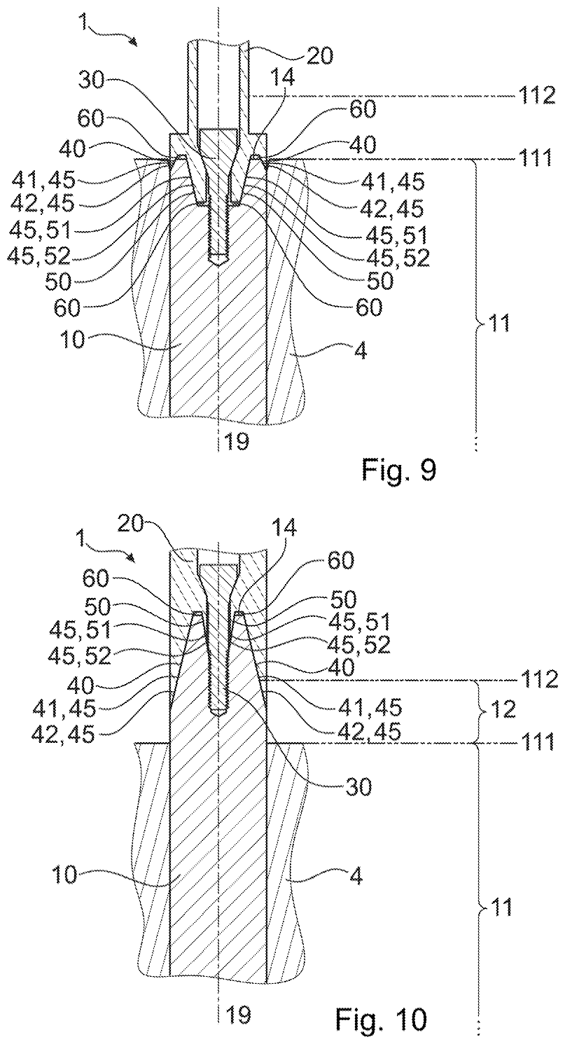

FIGS. 9 to 14 show examples of dental implant systems with an implant 10 that is anchored in a jawbone 4 and on which a prosthetics component 20 is fastened by way of a fastening means 30. In the shown examples, the tolerance distances 60 are reduced in size compared to a placed-on, but non-fastened state (not shown). In particular, drawn in the figures are:
the enossal region 11 of the implant 10, thus that region of the implant 10 that is configured to be sunk into the jawbone 4 and to ingrow with this;
the transmucosal region 12 of the implant 10 (inasmuch as existent), thus that region of the implant 10 that is configured to remain on the other side of the jawbone 4 and to be surrounded by soft tissue (not shown);
the bone boundary 111 of the jawbone 4; as well as
the soft tissue boundary 112 of the soft tissue (not shown).

The implant 10, which is shown in FIG. 9 is designed as a so-called “bone-level” implant, is therefore configured to terminate roughly level with the jawbone 4 at the bone boundary 111.

A first taper connection 40 is arranged on the implant 10 at the outside; the implant-side connection portion 41 of this first taper connection 40 is designed male. A second taper connection 50 is arranged in the implant recess 16; the implant-side connection portion 51 of this second taper connection 50 is female and is designed as a coronal end of the implant recess 16.

The implant 10 that is show in FIG. 10 is designed as a so-called “monotype” implant and is configured to terminate significantly beyond the soft tissue boundary 112. The shown prosthetics component 20 can be designed, for example, as a crown or outer sleeve.

A first taper connection 40 is arranged on the implant 10 at the outside; the implant-side connection portion 41 of this first taper connection 40 is designed male. The clamping surfaces 45 of this first taper connection—as is shown in FIG. 10—can be designed relatively long and extend, e.g., up to the soft tissue level or even into the submucosal region. A second taper connection 50 is arranged in the implant recess 16; the implant-side connection portion 51 of this second taper connection 50 is female and is designed as the coronal end of the implant recess 16.

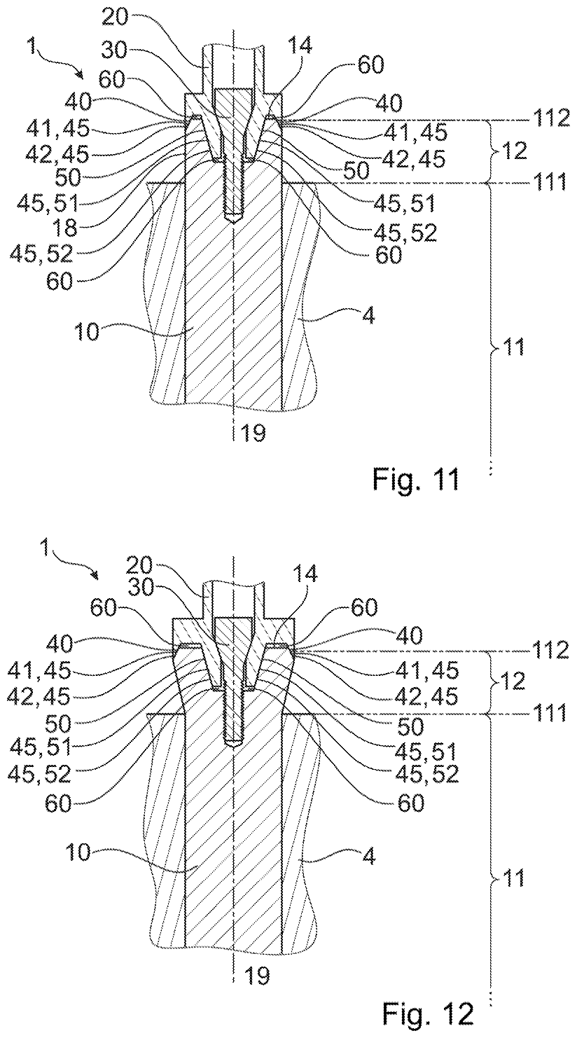

The implant 10 that is shown in FIG. 11 is designed as a so-called “tissue-level” implant and is therefore configured to terminate roughly level with the soft tissue at the soft tissue boundary 112.

A first taper connection 40 is arranged on the implant 10 at the outside; the implant-side connection portion of this first taper-connection 40 is designed male. The clamping surfaces 45 of this first taper connection 40—as is represented in FIG. 11—can be designed relatively short and be present in the form of a bevelling of the coronal implant end 14. The height of the bevelling, thus the length of the projection of the bevelling onto the implant axis 19 can be 1 mm at the most. The male connection portion of an implant 10 can be distanced to the enossal part, for example as shown in FIG. 11 by a flat support shoulder 18. The support shoulder 18 in the shown cross section is represented as two edges, which are parallel to the implant axis 19 and can be designed, for example, essentially as a circular cylinder. Due to the spacing, for example concerning a “tissue-level implant”, the advantage of an outer taper connection can be utilised and at the same time it can be ensured that the prosthetics component 20 ends at a biologically appropriate distance to the bone 4.

A second taper connection 50 is arranged in the implant recess 16; the implant-side connection portion 51 of this second taper connection 50 is female and is designed as the coronal end of the implant recess 16. As is shown in the shown example, the clamping surface 45 of a female second taper connection 50, which is arranged in a coronal end of the implant recess 16, can be designed longer in the connection direction than the clamping surface 45 of a male first taper connection 40, which is arranged at the outside.

The implant 10 that is shown in FIG. 12 is designed as a so-called “tissue-level” implant, thus is configured to terminate roughly level with the gums. Concerning the example, which is shown in FIG. 12, the transmucosal region 11 of the implant 10 is widened compared to the enossal region 12; this shape is also called “tulip”. The taper connections 40 of the example, which is shown in FIG. 12, are similar to those of the example shown in FIG. 11. As is also shown in this example, concerning tissue “level implants”, the outer clamping surfaces 45 can be distanced to the jawbone 4.

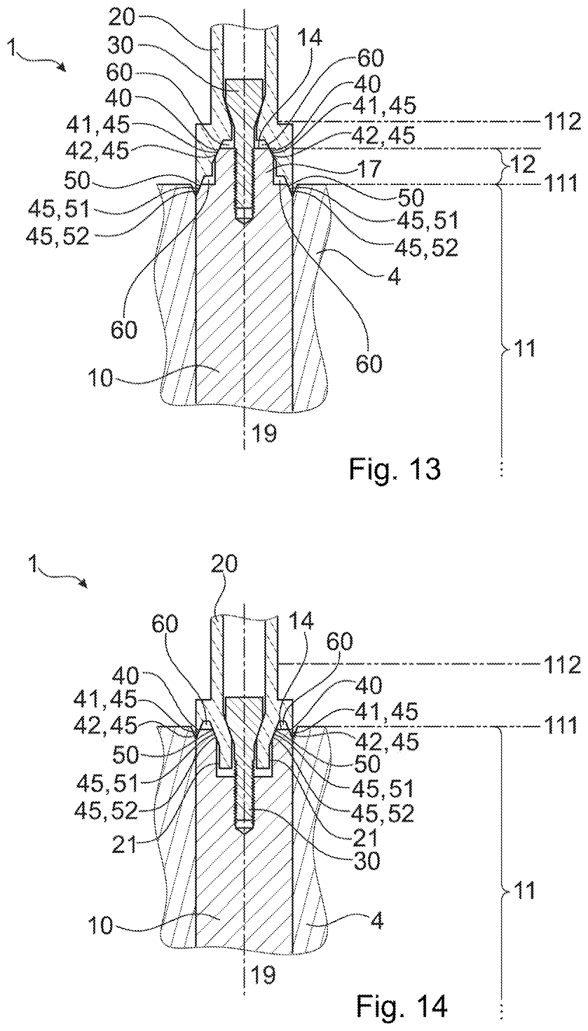

The implant 10 that is shown in FIG. 13 is configured to terminate essentially level with the jawbone 4 at a shoulder. Set back from the shoulder, a prominence 17 of the implant 10 is formed and this is configured to project into the mucosal region. The shown prominence 17 is also denoted as an “external head” for an “external connection”.

A dental implant system can include two taper connections 40, 50, whose implant-side connection portions 41, 51 are both designed male. An example of this is shown in FIG. 13: The second taper connection 50 is arranged on the coronal end of the prominence 17, which forms the coronal end 14 of the implant 10. The first taper connection 50 is arranged on a surface of the implant 10 that is distal (seen from the implant axis 19). In the shown example, this part of the distal surface is arranged roughly at the height of the bone boundary 111 after the implantation of the implant 10. The implant-side connection portions 41, 51 of the two shown taper connections 40, 50 are designed male and are each configured to be received by female counter-portions 42, 52 of the prosthetics component 20.

In the shown example, yet a third taper connection (not shown), which at the implant side (concerning the implant) could be designed, e.g., female could be arranged within the implant recess 16. Generally, two or more, in particular three or more, in particular four or more taper connections can be arranged between the implant 10 and the prosthetics component 20.

A dental implant system can include two taper connections 40, 50, of which one is arranged coronally of the other. FIG. 13 shows such an example: the first taper connection 50 in the implanted state is arranged essentially at the height of the jawbone 4; the second taper connection 40 is arranged on the coronal end of the prominence 17 that projects into the mucosal region.

The implant 10 that is shown in FIG. 14—similarly to the example in FIG. 9—is designed as a “tissue-level” implant. The first taper connection 40 is arranged at the outside on the coronal end 14 of the implant 10 and at the implant side is designed male. The second taper connection 50 is arranged at the inside in an implant recess 16 and at the implant side is designed female. In contrast to the example of FIG. 9, the lengths of the clamping surfaces 45 in the respective connection directions are essentially equal in the shown embodiment example.

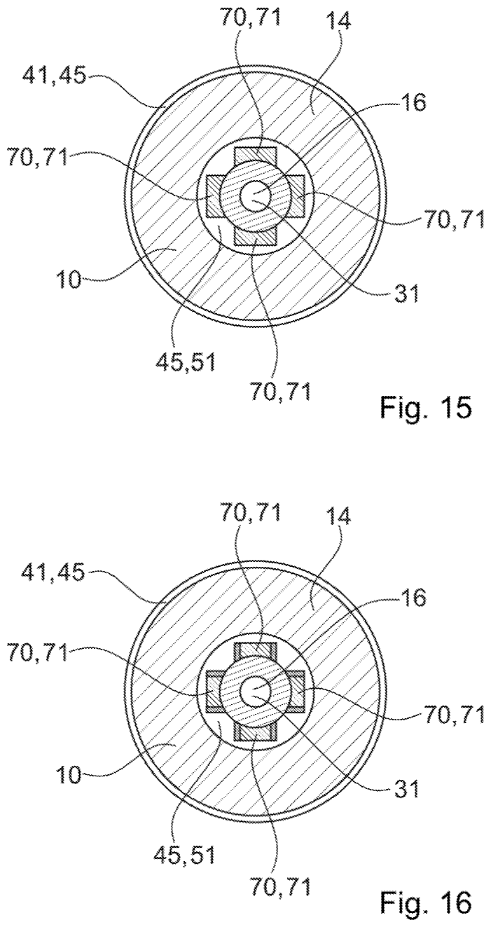

FIG. 15 shows an example of an implant from a coronal view which, in FIGS. 1-14, corresponds to a view “from above”. The coronal surface 14 of the implant 10 is delimited at the outside by a clamping surface 45 of a connection portion 41 for a first taper connection and from the inside by a clamping surface 45 of a connection portion 51 for a second taper connection.

In the shown example, the implant-side clamping surface 45 of the outer, first taper connection 40 is designed as a truncated cone. The clamping surface 45 of the second taper connection 50 is arranged in an implant recess 16 and is designed as a truncated cone with structure elements 70.

Structure elements 70 are geometric particularities that can function as an orientation aid, positioning aid and/or twist (rotation) protection for placing and/or fastening the prosthetics component on/onto the implant 10.

In an embodiment, an implant 10 can include structure elements 70 and a prosthetics component can include structure elements 70 that match with these. For example, the implant 10 can include notches 71 and the prosthetics component 20 can include projections (not shown) that match with these. Of course the notches and projections can also be arranged the outer way round or mixed. A structure element 70 of the implant 10 and a structure element 70 of the prosthetics component 20 can be adapted to one another, in particular designed at least partly as a negative shape of the other.

In the shown example, structure elements 70 are formed by recesses, thus notches 71, in the clamping surface 45 of the implant-side connection portion 51 of the second taper connection. As a whole, four such structure elements 70 are represented in the shown cross section and these—as shown in the example—can be arranged rotationally symmetrically and offset to one another by 90°.

Structure elements 70 can, for example, include a box-like geometry, thus be designed locally as a section of a cuboid, which possibly tapers in one or more directions and which is with a steep clamping surface 45 and/or other parts of the implant 10 or of the prosthetics component 20. The structure elements 70, which are shown in FIG. 15, are designed as a section of a cuboid with the clamping surface 45 and accordingly manifest themselves as a rectangle in the represented cross section, with regard to which one of the sides is arcuate according to the curvature of the clamping surface 45. Other sides can also be arcuate.

Structure elements 70 can be arranged at least partly in a clamping surface 45 of a taper connection, but also coronally and/or apically of a clamping surface 45 and even arranged distanced to a clamping surface.

FIG. 16 shows an example of an implant 10 from the coronal view similarly to FIG. 15. In contrast to the example of FIG. 15, the structure elements 70 do however taper in the apical direction. In a cross section, which is perpendicular to the shown cross-section, the structure elements 70 can have, for example, a trapezoidal shape.

A tapering of a structure element 70 can be, e.g., 8° or less than 8° (relative to the implant axis 19) and for its part can again function as a clamping surface 45, by which means the total surface of the clamping surfaces between the implant 10 and the prosthetics component 20 can be enlarged.

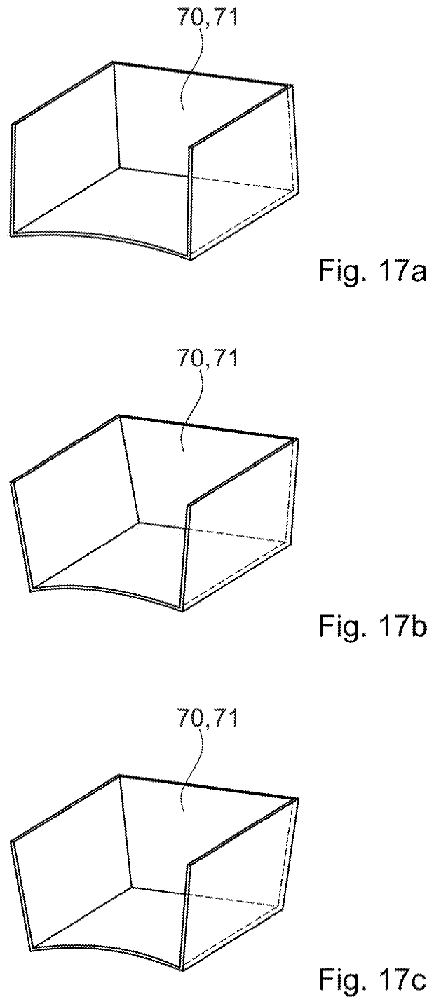

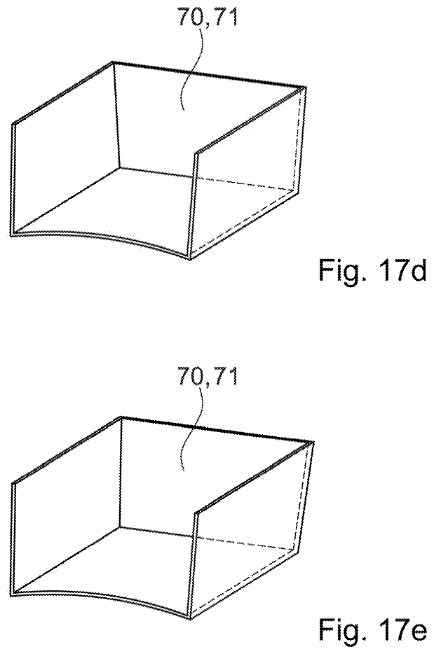

FIG. 17 shows five examples of box-like structure elements 70, which are designed as notches 71. The notches 71 can be arranged in an implant 10 and/or in a prosthetics component 20, e.g., within a clamping surface.

FIG. 17a shows a structure element 70 designed as a section of a cuboid with a steep clamping surface, with regard to which the front edges—corresponding to the shape of the steep clamping surface—can differ from the perpendicular by a few degrees.

FIG. 17b shows a structure element 70 designed as a section of a cuboid that tapers in width and is with a steep clamping surface. Steep clamping surfaces can again arise due to the tapering.

FIG. 17c shows a structure element designed as a section of cuboid that tapers in width and in depth and which is with a steep clamping surface. The structure element therefore tapers in two different dimensions. In the shown example, three steep clamping surfaces arise on account of this.

FIG. 17d shows a structure element 70 as a section of a cuboid tapering at a wall. In the shown example, this is the right wall.

FIG. 17e shows a structure element 70 as a section of a cuboid, the cuboid tapering in two different dimensions. In the shown example, the right wall as well as the rear wall taper.

Concerning box-like structure elements 70, such as, e.g., those which are shown in FIGS. 17a to 17e, one or more straight edges can be designed as semi-circular arches or other shapes.

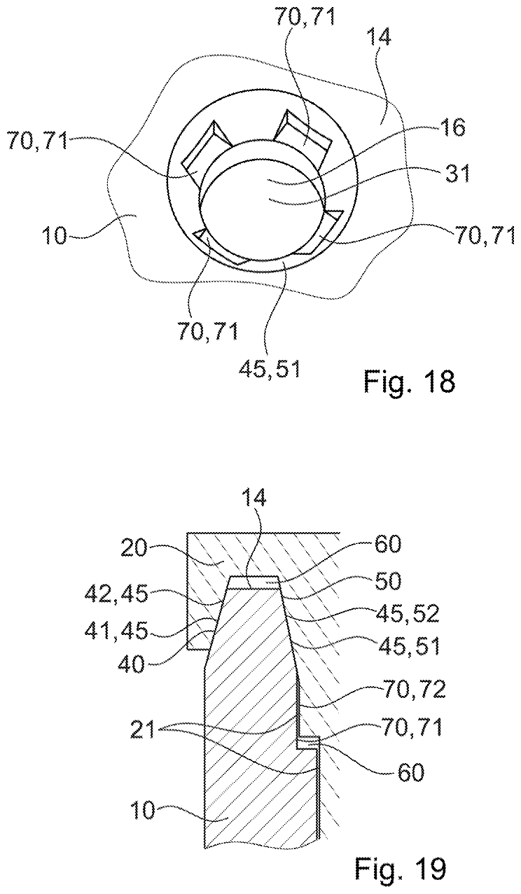

FIG. 18 shows a detail of a perspective view of an implant 10. The implant 10 at its coronal end 14 includes an implant recess 16 with a fastening means recess 31. The coronal end of the inner wall of the implant recess 16 is designed as a clamping surface 45 of a female connection portion 51 for a taper connection. The clamping surface 45 is designed as a truncated cone with four structure elements 70 in the form of box-like notches 71. The four notches 71 are arranged in the clamping surface 45 offset to one another by 90°.

FIG. 19 shows a detail of a cross section of an implant 10 as well as of a prosthetics component 20, wherein the cross-sectional plane contains the coronal-apical direction. As can be recognised on the left side of the Figure, the implant 10 at the outside includes a clamping surface 45 of a male connection portion 41. It can be recognised on the right side of the figure that the implant 10 at the inside includes a clamping surface 45 of a male connection portion 51.

The clamping surface 45 of the inner, female connection portion 51 of the implant includes a structure element 70, which is designed as a notch 71 and which is formed at the apical end of the clamping surface 45. The corresponding male connection portion 52 of the prosthetics component 20 includes a structure element, which is arranged and designed in a manner corresponding to this, in the form of a projection 72. The projection 72 is designed essentially as a negative of the notch 71 and is configured to commonly assume a positive fit together with the notch 71. In the shown example, the two shown structure elements 70 are each designed as a step.

The show example includes two tolerance regions between the implant 10 and the prosthetics component 20. A first tolerance region is arranged coronally of the coronal end 14 of the implant 10 and is adjacent to the two shown taper connections 40, 50. A second tolerance region is arranged at the apical end of the second, inner connection 50, at the apical end of the two shown structure elements 70. On fastening, the prosthetics component 20 can be pushed further into the implant 10 due to the two shown tolerance regions 60 and in particular the respective gap at the respective connections 40, 50 can therefore be reduced, in particular minimised.

1. A dental implant system, comprising
an implant for anchoring in bone tissue,
a prosthetics component, which is configured to be placed onto the implant, and
a fastener, which is suitable for fastening the prosthetics component to the implant,
wherein the implant and the prosthetics component are configured to assume a first taper connection and a second taper connection with one another,
wherein the implant comprises the male connection portion of the first taper connection, and
wherein
when the prosthetics component is placed onto the implant and
when the prosthetics component is not fastened to the implant by the fastener,
a tolerance region is formed between the implant and the prosthetics component, said tolerance region being configured such that on fastening with the fastener, mating connection portions of the taper connections can be pushed further into one another.

2. The dental implant system according to claim 1, wherein
an implant-side connection portion of the first taper connection and/or
an implant-side connection portion of the second taper connection
is arranged at the coronal end of the implant.

3. The dental implant system according to claim 1, wherein an implant-side connection portion of the second taper connection is designed as a female connection portion,
and wherein the implant-side connection portion of the second taper connection is designed as part of an implant recess.

4. The dental implant system according to claim 1, wherein an implant-side connection portion of the second taper connection is designed as a male connection portion,
and wherein
an implant-side connection portion of the first taper connection is arranged at the coronal end of the implant, and
the implant-side connection portion of the second taper connection is arranged on a surface of the implant, which is distal to the implant axis,
and wherein the implant-side connection portion of the second taper connection is arranged apically of the implant-side connection portion of the first taper connection.

5. The dental implant system according to claim 1, wherein an angle of the clamping surfaces of the first taper connection and/or of the second taper connection to the implant axis is 8° or less than 8°.

6. The dental implant system according to claim 1, wherein a length of a projection of a clamping surface of the implant onto an implant axis is 1 mm at the most.

7. The dental implant system according to claim 1, wherein a tolerance region in the non-fastened state is designed as a distance between the implant and the prosthetics component in a coronal-apical direction,
wherein the distance between the implant and the prosthetics component in the coronal-apical direction is at least 100 μm in the non-fastened state.

8. The dental implant system according to claim 1, wherein the fastener comprises a thread,
and wherein the fastener is designed as a screw.

9. The dental implant system according to claim 1, wherein the implant and/or the prosthetics component comprises structure elements that are designed as an orientation aid, a positioning aid and/or a twist protection.

10. The dental implant system according to claim 9, wherein the structure elements are designed as notches and corresponding projections,
and wherein the notches and projections are designed at least essentially box-shaped,
and wherein the notches and projections taper in the coronal and/or apical direction.

11. The dental implant system according to claim 9, wherein a structure element is arranged
in a connection portion and/or
apically of the connection portion.

12. The dental implant system according to claim 1, wherein the prosthetics component is designed as an abutment, crown or outer sleeve.

13. A method for fastening a dental implant system comprising:
an implant for anchoring in the bone tissue,
a prosthetics component, which is configured to be placed onto the implant, and
a fastener, which is suitable for fastening the prosthetics component to the implant,
wherein the implant and the prosthetics component are configured to assume a first taper connection and a second taper connection with one another,
wherein the implant comprises a male connection portion of the first taper connection, and
wherein
when the prosthetics component is placed upon the implant and
when the prosthetics component is not fastened to the implant by the fastener,
a tolerance region is formed between the implant and the prosthetics component, said tolerance region being configured such that on fastening with the fastener, the male connection portion and female connection portion of the taper connections can be pushed further into one another in the fastening force direction,
wherein
a) the prosthetics component is placed onto the implant; and
b) the prosthetics component is subsequently fastened to the implant by the fastener, wherein the male connection portions and female connection portions of the taper connections are pushed further into one another on fastening.
